(19) United States
(12) Patent Application Publication
(10) Pub. No.: US 2017/0120885 A1
(43) Pub. Date: May 4, 2017

(54) ABS SENSOR CLEANING SYSTEM

(71) Applicant: VOLVO DO BRASIL VEÍCULOS LTDA., Curitiba (BR)

(72) Inventors: Paulo Roberto MULLER, Curitiba (BR); Luciano SCOPARO, Curitiba (BR)

(21) Appl. No.: 15/127,163

(22) PCT Filed: Apr. 10, 2014
(86) PCT No.: PCT/BR14/00122

§ 371 Date: Sep. 19, 2016

(51) Int. Cl. B60T 17/22; B08B 3/02; B08B 5/02

(52) U.S. Cl. CPC B60T 17/221; B08B 5/02; B08B 3/02

(57) ABSTRACT

A cleaning method and system for anti-lock breaking systems (ABS), includes a nozzle mounted in close proximity to an ABS sensor. The nozzle is configured to emit pressurized fluid directed toward at least one of a sensor fixed component or sensor rotating component to remove dust, dirt, or other debris.

### FIELD OF INVENTION

The present disclosure related to vehicles having anti-lock brake systems (ABS) with wheel sensors.

### BACKGROUND

Anti-lock braking systems (ABS) denote a category of vehicle safety systems characterized by an ability to minimize lockout or skidding of wheels. Anti-lock braking systems commonly include a wheel sensor arranged at each wheel. These sensors create a signal whose frequency is proportional to the rotational speed of the respective wheel. The frequency of the signal from each wheel is then compared to the signals from the other wheels to detect wheel lock. p Anti-lock braking systems depend on accurate signals from the sensors for proper operation of the brakes. However, placement of the sensors near the wheels can leave the sensors susceptible to becoming caked with dust, dirt, oil and other debris. The sensors can be exposed to large amounts of brake dust, as well as splashed with mud, oil or other road grime from the tires. Debris can accumulate to such a degree that the sensors produce inaccurate or inconsistent signals, resulting in the possible malfunction of a vehicle's ABS. As the number of off-road vehicles equipped with ABS increases, this problem will become more prevalent due to the harsh environments of off-road driving.

If the ABS malfunctions, current practice is to disassemble the wheel ends and to clean the sensors, as well as other components, by hand. This is a labor intensive process often complicated by the placement of the sensors behind the hub or disk brake. In the case of vehicles with drum brakes, the brakes may also have to be disassembled, further increasing the cleaning time. In most cases, this manual cleaning process occurs only after an error is detected, and not as a matter of regular preventative maintenance.

### SUMMARY

The inventors have developed a system and method for actively maintaining the performance of sensors used in anti-lock braking systems by minimizing buildup of dust and debris on the sensors. The cleaning provided by the system will minimize ABS malfunctions caused by dirty sensors, improving safety and reliability, reducing maintenance costs, and extending uptime for the equipped vehicle.

The present disclosure includes a ABS cleaning system, comprising: a sensor, the sensor comprising: a fixed component; and a rotating component adjacent to the fixed component, the sensor generating a signal based upon relative motion of the fixed component and the rotating component; and b) a cleaning system configured to be mounted in close proximity to the sensor, the cleaning system comprising: a nozzle, the nozzle configured to emit pressurized fluid to remove debris from either the fixed component or the rotating component, or both.

The present disclosure also includes a nozzle for cleaning an anti-lock brake system (ABS) comprising a sensor with a fixed component and a rotating reference, the nozzle comprising: a body defining a fluid channel, the fluid channel comprising: an inlet for connection to a source of pressurized fluid, at least one first outlet for directing pressurized fluid in a first direction, toward the rotating reference, to remove debris therefrom; and at least one second outlet for directing pressurized fluid in a second direction, toward the fixed component, to remove debris therefrom.

The present disclosure also include a method of maintaining an anti-lock brake system (ABS) having at least one sensor, comprising: a) mounting a nozzle in close proximity to the at least one sensor; b) fluidly connecting the nozzle to a source of compressed air; c) providing a valve between the nozzle and the source of compressed air; d) opening the valve; and e) emitting pressurized air from the nozzle toward at least a portion of the at least one sensor, when the valve is open, to remove debris from the at least one sensor.

### BRIEF DESCRIPTION OF THE DRAWINGS

FIG. 1 is a schematic of an anti-lock braking system according to embodiments of the present disclosure.

FIG. 2 is a top perspective view of a wheel end having the system according to embodiments of the present disclosure.

FIG. 3 is an enlarged view of the system shown in FIG. 2.

FIG. 4 is a schematic view of the system to embodiments of the present disclosure.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

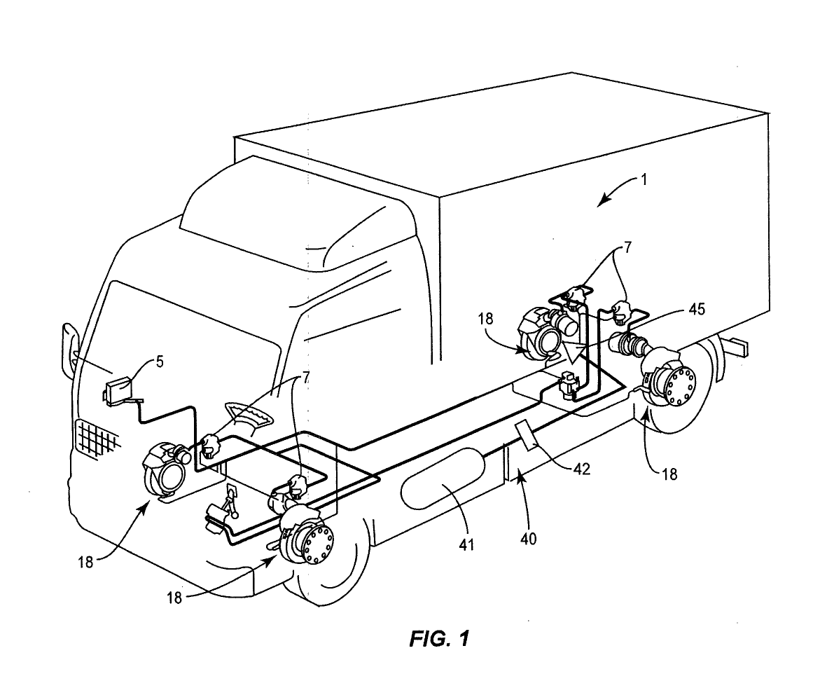

An anti-lock braking system (ABS) 1 according to embodiments of the present disclosure is shown schematically in FIG. 1. The ABS 1 can include a plurality of sensors 18 for a plurality of wheels. A hydraulic valve 7 can also be associated with the brake lines running to each wheel end. An electronic controller 5 is in communication with each sensor 18 and the plurality of hydraulic valves 7. Each sensor 18 generates a signal for the electronic controller 5 with a frequency proportional to the rotational speed of the respective wheel. The controller 5 in turn monitors the input from each sensor 18 and compares the frequency of each sensor's 18 signal. The controller 5 will then activate the proper hydraulic valve 7 to compensate and attempt to equalize the varied frequencies. For example, where one wheel is spinning faster than the rest, producing a higher frequency signal through the respective sensor 18, the hydraulic valve 7 associated with that wheel can be set to increase the hydraulic pressure, thereby increasing braking force and slowing the particular wheel compared to the rest of the wheels. On the other hand, if one of the wheels is found to be spinning significantly slower than the others, indicating potential wheel lock, the respective hydraulic valve 7 can be operated to reduce the available hydraulic pressure on the respective brakes, allowing the increase in speed relative to the other wheels which are under greater braking forces.

The ABS 1 of the present disclosure also includes a cleaning system 40 having a nozzle 45 in close proximity to each sensor 18 (only one nozzle 45 shown). The cleaning system 40 may also include a source 41, such as a tank of compressed air, for feeding pressurized fluid to the nozzle 45. Further, the cleaning system 40 may include at least one fluid valve 42 is disposed between the source 41 and the nozzles 45 to control flow of the pressurized fluid to the nozzles 45.

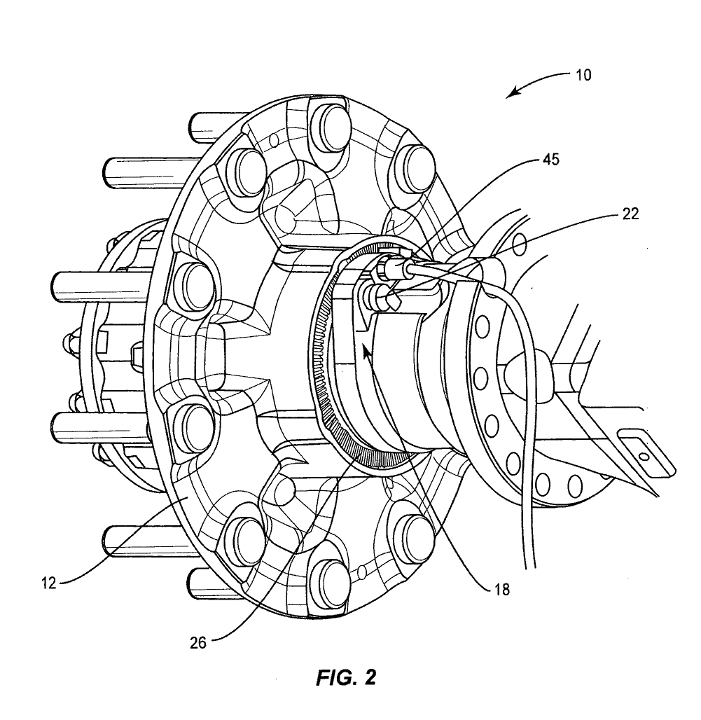

FIG. 2 shows a wheel end assembly 10 including features of the present disclosure. The wheel end assembly 10 includes a rotating hub 12. The sensor 18 may comprise a fixed component, such as a magnet 22, that is fixedly mounted as part of the wheel end assembly 10. As used herein, the term “fixed” is used to describe components that do not rotate as a vehicle travels. The term “fixed” is not limited to features that are completely stationary relative to the vehicle. For example, the magnet 22 may be fixed relative to the rotating hub 12, but wheel end assembly 10 and the magnet 22 may travel up and down relative to the vehicle body due to the use of a suspension system.

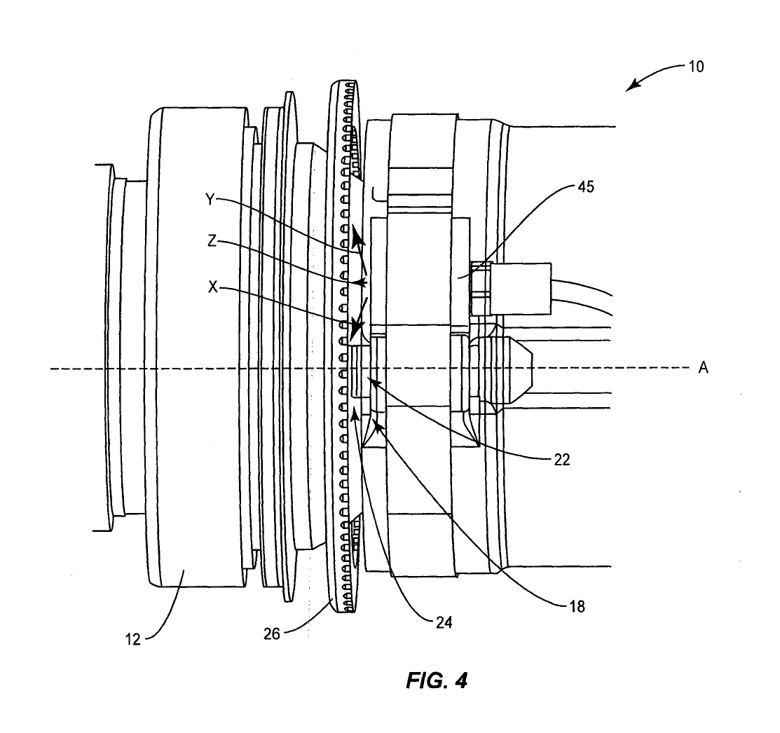

As best seen in FIG. 4, the sensor 18 may also comprise a rotating component, such as a reference ring 26. The reference ring 26 is preferably metallic, and is mounted such that it rotates along with the hub 12. The ring 26 has teeth 30. The teeth 30 protrude in a direction parallel with the axis of rotation A of the ring 26. The ring 26 may have alternative structures capable of providing reference for the magnet 22, such as apertures equally spaced around the circumference of the ring 26, or teeth 30 evenly spaced and extending in a radial direction, providing a serrated edge with several notches. While the magnet 22 is shown positioned adjacent to the face of the ring 26, other embodiments of the ring 26 may require the magnet 22 to be positioned adjacent to the peripheral surface of the ring 26. The reference ring 26 may be a dedicated element of the sensor 18 or may simultaneously function as the brake disk within a disk-brake system. The sensor 18 uses the spinning reference ring 26, positioned with teeth 30 in close proximity to the magnet 22, to produce a signal due to flux variations caused by the periodic nature of the teeth 30 passing through the vicinity of the magnet 22. In other embodiments the magnet 22 may form the rotating component of the sensor 18 and a transducer may form the fixed component.

Dust and debris can accumulate on the magnet 22 and between the teeth 30 of the reference ring 26. In other words, dust and debris can accumulate between the rotating component and the fixed component of the sensor 18. The quantity of dust combined with any metallic particles in the mix can cause the sensor 18 to produce an inconsistent signal, one lacking a clean frequency associated with the actual rotational speed of the hub 12.

As shown in FIGS. 1-4, the present disclosure provides a cleaning system 40 in the form of a nozzle 45 in close proximity to the sensor 18. In the embodiment shown, the nozzle 45 is positioned adjacent to the fixed component, magnet 22. In other embodiments, the nozzle 45 may be spaced from the magnet 22 at a distant location around the rotational axis A. The nozzle 45 is configured to minimize debris on the sensor 18. To do this, the nozzle 45 may emit pressurized fluid designed to remove dust from the area of the sensor 18. In one embodiment, the nozzle 45 can emit pressurized air. Compressed air may be preferable because vehicles, particularly commercial and industrial trucks, are generally equipped with air compressors for use on existing brake and suspension systems. Therefore the nozzle 45 can use the existing source 41 of compressed air without requiring a dedicated compressor or separate source. In other embodiments, liquids may be sprayed from the nozzle 45. Liquids may be able to provide a higher cleaning efficiency under a lower pressure compared to the use of compressed air.

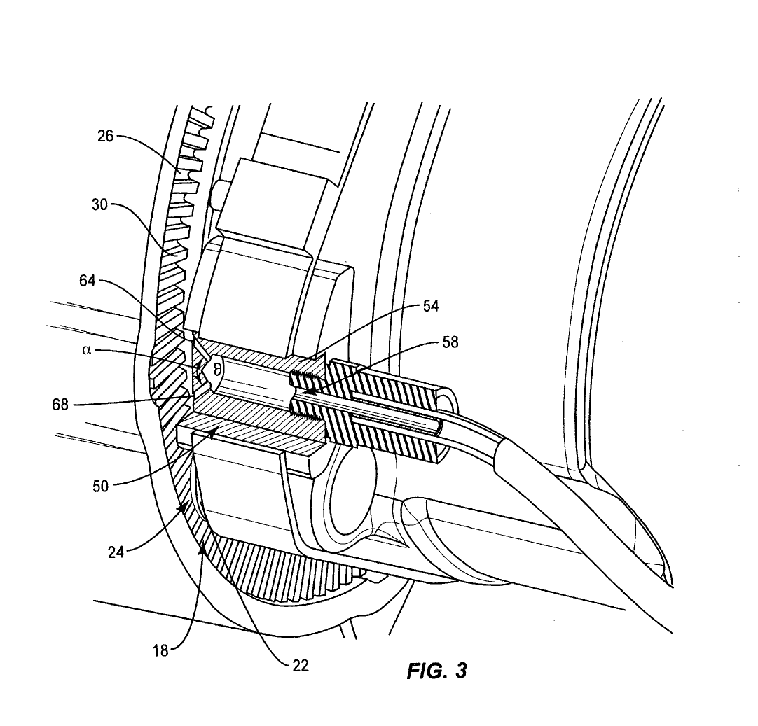

FIG. 3 shows the wheel end assembly 10 of FIG. 2 with the nozzle 45 shown in cutaway cross-section. The nozzle 45 may include a nozzle body 54 defining a fluid channel through the nozzle 45. The fluid channel will include an inlet 58 for connection to a source (not shown in FIG. 3) of pressurized fluid, for example, a truck's compressed air system. The fluid channel may include one or more outlets 64, 68 for directing pressurized fluid toward the sensor 18. In some embodiments, the nozzle 45 emits fluid at between about 2 and about 20 bar.

In the embodiment shown in FIG. 3, the nozzle 45 includes at least one reference outlet 64 configured to emit fluid toward the reference ring 26 to remove debris from the teeth 30 of the ring 26. The nozzle 45 also includes at least one magnet outlet 68 configured to emit fluid toward and dislodge debris from the magnet 22. In the illustrated embodiment, the magnet outlet 68 emits fluid in a direction toward a gap 24 between the magnet 22 and the ring 26. In one embodiment, the reference outlets 64 may form an angle alpha (α) with the magnet outlets 68, where α is between about 15 and about 145 degrees.

FIG. 4 schematically represents the emission of fluid from an alternative nozzle 45. In this embodiment, fluid is emitted in three directions: toward the magnet 22 as represented by arrow X, away from the magnet 22 as represented by arrow Y, and substantially perpendicular to the ring 26 as represented by arrow Z. In some embodiments, the Z direction is substantially parallel to the axis of rotation A. Emission along each of the three directions X, Y and Z may be provided by separate outlets 64, 68. For example, fluid traveling in the X direction can be emitted from the magnet outlet 68, fluid traveling in the Y direction can be emitted from the reference outlet 64, and fluid traveling in the Z direction can be emitted from a third outlet (not shown). Alternatively, a single opening may be configured to discharge a fan-shaped spray pattern.

Preferably, the nozzle 45 is in fluid communication with a fluid valve 42 shown in FIG. 1. The fluid valve 42 may be a solenoid valve. The fluid valve 42 is positioned between the inlet 58 and the source 41 of pressurized fluid. The fluid valve 42 may have an open position allowing fluid to flow through the nozzle 45 and be sprayed therefrom, and a closed position in which the fluid valve 42 prevents fluid from reaching the nozzle 45. In some embodiments, the fluid valve 42 can toggle between the open and closed states with a predetermined pattern. To provide selective cleaning of the sensor 18, the fluid valve 42 may open daily or hourly. This rate may be predetermined or may vary based upon the speed of the vehicle or the environment in which the vehicle is used. For example, a truck intended for highway use may trigger the cleaning system 40 infrequently (daily), while a truck intended for off-road use may trigger the cleaning system 40 regularly (hourly). The fluid valve 42 may be linked to a manual override allowing the driver to activate the cleaning system 40 on demand if the truck is used under extraordinary conditions. The fluid valve 42 may remain open for between five and sixty seconds before returning to the closed position. In some embodiments the fluid valve 42 can be controlled by the vehicle's electronic control unit and related software. To simplify the cleaning system 40, the fluid valve 42 can selectively switch to the open position without determining the amount of buildup on the sensor 18. Alternatively, additional detectors could be added to invoke the cleaning system 40 only when high levels of buildup are present. In other embodiments, the fluid valve 42 could be omitted entirely, in which case the nozzle 45 would continuously spray the sensor 18 with pressurized fluid when the vehicle is running.

The ABS 1 with the cleaning system 40 discussed above provides the basis for a method of maintaining an abs 1 with at least one sensor 18. The method includes the following steps:

a) mounting a nozzle 45 in close proximity to each of the at least one sensor 18;

b) fluidly connecting the nozzle 45 to a source 41 of compressed air;

c) providing a fluid valve 42 between the nozzle 45 and the source 41 of compressed air;

d) opening the fluid valve 42; and

e) emitting pressurized air from the nozzle 45 toward at least a portion of the at least one sensor 18, when the fluid valve 42 is open, to remove debris from the at least one sensor 18.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. A cleaning system for an ABS system, the ABS system having a sensor with a fixed component and a rotating component adjacent to the fixed component, the sensor generating a signal based upon relative motion of the fixed component and the rotating component, comprising:
a cleaning nozzle configured to be mounted in close proximity to the sensor, and configured to emit pressurized fluid directed to at least one of the fixed component or the rotating component.

2. The system according to claim 1, wherein the cleaning nozzle is adapted to connect to a source of pressurized fluid.

3. The system according to claim 2, wherein the pressurized fluid is compressed air.

4. The system according to claim 2, wherein the pressurized fluid is a liquid.

5. The system according to claim 1, wherein the nozzle emits the fluid toward the fixed component.

6. The system according to claim 1, wherein the nozzle emits the fluid toward the rotating component.

7. The system according to claim 1, wherein the nozzle emits fluid in a direction of a gap between the fixed component and the rotating component.

8. The system according to claim 1, wherein the nozzle emits fluid at between about 2 and about 20 bar.

9. The system according to claim 1, further comprising a valve in fluid communication with the nozzle to control flow from a source of pressurized fluid, wherein the valve opens to allow the nozzle to emit the pressurized fluid.

2. The system according to claim 9, wherein opening of the valve can vary based upon a wheel rotational speed sensed by the sensor.

3. A nozzle for cleaning an anti-lock brake system (ABS) comprising a sensor with a fixed component and a rotating reference, the nozzle comprising:
a body defining a fluid channel, the fluid channel comprising:
an inlet for connection to a source of pressurized fluid,
at least one first outlet for directing pressurized fluid in a first direction, toward the rotating reference, to remove debris therefrom; and
at least one second outlet for directing pressurized fluid in a second direction, toward the fixed component, to remove debris therefrom.

4. The nozzle according to claim 3, wherein the at least one first outlet forms an angle with the at least one second outlet of between about 15 and about 150 degrees.

5. The nozzle according to claim 3, wherein the first direction is configured to be substantially parallel with an axis of rotation of the reference.

6. The nozzle according to claim 3, wherein the second direction is configured toward a gap between, the rotating reference and the sensor.

7. A method of maintaining an anti-lock brake system (ABS) having at least one sensor, comprising:
a) mounting a nozzle in close proximity to the at least one sensor;
b) fluidly connecting the nozzle to a source of compressed air;
c) providing a valve between the nozzle and the source of compressed air;
d) opening the valve; and
e) emitting pressurized air from the nozzle toward at least a portion of the at least one sensor, when the valve is open, to remove debris from the at least one sensor.

8. The method of claim 7, wherein the valve is opened and closed at pre-selected intervals.

9. The method of claim 7, wherein the step of emitting pressurized air comprises emitting air at between about 2 and about 20 bar.

10. The method of claim 7, wherein the step of emitting pressurized air toward a portion of the at least one sensor comprises emitting air toward a fixed component of the sensor.

19. The method of claim 7, wherein the step of emitting pressurized air toward a portion of the at least one sensor comprises emitting air toward a rotating component of the sensor.
